(19) United States
(12) Patent Application Publication
(10) Pub. No.: US 2018/0113661 A1
(43) Pub. Date: Apr. 26, 2018

(54) INFORMATION PROCESSING DEVICE, IMAGE FILE DATA STRUCTURE, AND NON-TRANSITORY COMPUTER-READABLE MEDIUM

(71) Applicant: FUJI XEROX CO., LTD., Tokyo (JP)

(72) Inventors: Kengo TOKUCHI, Kanagawa (JP); Motofumi BABA, Kanagawa (JP); Yoshihiko NEMOTO, Kanagawa (JP); Masahiro SATO, Kanagawa (JP)

(73) Assignee: FUJI XEROX CO., LTD., Tokyo (JP)

(21) Appl. No.: 15/485,762

(22) Filed: Apr. 12, 2017

(30) Foreign Application Priority Data
Oct. 24, 2016 (JP) 2016-207903

(51) Int. Cl. G06F 3/12; H04N 1/32; H04N 1/00

(52) U.S. Cl. CPC G06F 3/1275; H04N 1/32149; G06F 3/1297; H04N 2201/328; G06F 3/1285; H04N 1/00413; H04N 2201/3242; G06F 3/1208

(57) ABSTRACT

An information processing device includes a recognition unit and a controller. The recognition unit recognizes a user instruction with respect to a subject included in an image. If information related to the subject is stated in an execution language in a part of attribute information attached to a data file of the image, the controller executes a workflow process prescribed by the information.

### CROSS-REFERENCE TO RELATED APPLICATIONS

This application is based on and claims priority under 35 USC 119 from Japanese Patent Application No. 2016-207903 filed Oct. 24, 2016.

### BACKGROUND

### Technical Field

The present invention relates to an information processing device, an image file data structure, and a non-transitory computer-readable medium.

### SUMMARY

According to an aspect of the invention, there is provided an information processing device including a recognition unit that recognizes a user instruction with respect to a subject included in an image, and a controller that, if information related to the subject is stated in an execution language in a part of attribute information attached to a data file of the image, executes a workflow process prescribed by the information.

### BRIEF DESCRIPTION OF THE DRAWINGS

Exemplary embodiment of the present invention will be described in detail based on the following figure, wherein:

FIG. 1 is a diagram illustrating an exemplary data structure of a JPEG file used in an exemplary embodiment;

FIG. 2 is a diagram illustrating an exemplary configuration of an image processing system used in an exemplary embodiment;

FIG. 3 is a diagram illustrating an exemplary configuration of a computer according to an exemplary embodiment;

FIG. 4 is a diagram illustrating an exemplary configuration of an image forming device according to an exemplary embodiment;

FIG. 5 is a diagram illustrating an example of a still image used in respective usage scenarios;

FIG. 6 is a block diagram illustrating an example of a functional configuration of a control unit expressed from the perspective of a function that processes a JPEG file including information prescribing a workflow process as attribute information;

FIG. 7 is a flowchart illustrating an example of a processing sequence executed by a control unit;

FIG. 8 is a diagram explaining up to the output of a command in Usage Scenario 1;

FIG. 9 is a diagram explaining an example of a change in a display mode added to a still image in Usage Scenario 1;

FIG. 10 is a diagram explaining an exemplary operation in a case of copying a JPEG file in which information prescribing a workflow process is stated in attribute information;

FIG. 11 is a diagram explaining another exemplary operation in a case of copying a JPEG file in which information prescribing a workflow process is stated in attribute information;

FIG. 12 is a diagram illustrating an exemplary display of a popup window to confirm the copying of information prescribing a workflow process, displayed at the time of copying a JPEG file;

FIG. 13 is a diagram explaining an exemplary operation in a case of deleting a subject for which information prescribing a workflow process is stated in attribute information from a corresponding still image by image editing;

FIG. 14 is a diagram explaining an exemplary operation in a case of copying or cutting one subject for which information prescribing a workflow process is stated in attribute information by image editing;

FIG. 15 is a diagram illustrating an example of arranging small images of electronic equipment copied or cut out from multiple still images into a single still image;

FIGS. 16A and 16B are diagrams explaining an exemplary screen that appears in a case of pasting an image of a JPEG file, in which information prescribing a workflow process is stated in attribute information, into an electronic document;

FIGS. 17A and 17B are diagrams explaining another exemplary screen that appears in a case of pasting an image of a JPEG file in which information prescribing a workflow process is stated in attribute information into an electronic document;

FIG. 18 is a diagram explaining a usage scenario of embedding into a still image and printing a coded image with low visibility expressing the content of attribute information;

FIG. 19 is a flowchart illustrating an example of a process executed by a control unit in a case of printing a JPEG file;

FIG. 20 is a diagram explaining how a coded image and a still image are separated from a composite image, and attribute information is reconstructed from the coded image;

FIG. 21 is a flowchart illustrating an example of a process executed by a control unit in a case in which a coded image generated from attribute information is embedded into a printed image;

FIG. 22 is a diagram explaining a case in which information prescribing a workflow process is stated in association with a person;

FIG. 23 is a block diagram illustrating an example of a functional configuration of a control unit expressed from the perspective of recording information prescribing a workflow process;

FIG. 24 is a diagram explaining an example of the specification of an image region by a user; and

FIGS. 25A and 25B are diagrams explaining the writing of information prescribing a workflow process into attribute information.

### DETAILED DESCRIPTION

Hereinafter, exemplary embodiments of the invention will be described in detail and with reference to the attached drawings. Although the following describes exemplary embodiments applied to still image files, the present invention may also be applied to moving image files. Also, in the following exemplary embodiments, an example of a JPEG file conforming to the JPEG format is described for the sake of convenience, but the present invention may also be applied to another still image file that includes attribute information as part of the data.

<Data Structure of Still Image File>

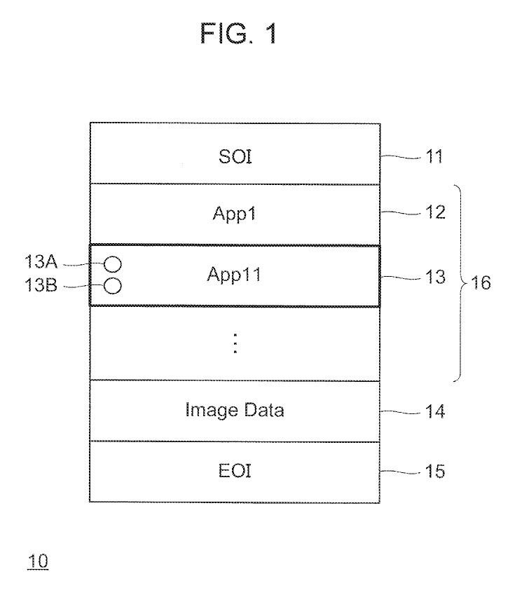

FIG. 1 is a diagram illustrating a data structure of a JPEG file 10 used in an exemplary embodiment. The JPEG file 10 is an example of an image data file, and conforms to the JPEG format.

The JPEG file 10 includes a start of image (SOI) segment 11 that indicating the start position of the image, an application type 1 (App1) segment 12 used to state Exif information and the like, an application type 11 (App11) segment 13 used to state information prescribing a workflow process related to a subject, image data (ID) 14, and an end of image (EOI) segment 15 that indicates the end position of the image. Herein, the image data 14 is an example of a first data region, while the application type 11 segment 13 is an example of a second data region. The still image itself is saved in the image data 14.

The region between the start of image segment 11 and the end of image segment 15 is also called a frame. Note that, although not indicated in FIG. 1, a JPEG file also includes two segments which are not illustrated, namely a define quantization table (DQT) segment and a define Huffman table (DHT) segment. Segments other than the above are placed as appropriate. In the case of FIG. 1, the application type 1 segment 12 and the application type 11 segment 13 are attribute information 16 of the JPEG file 10. Consequently, each of the application type 1 segment 12 and the application type 11 segment 13 is a part of the attribute information 16.

In the application type 11 segment 13 of FIG. 1, there is stated information 13A and 13B prescribing a workflow process related to a subject included in the still image created by the JPEG file 10. For example, the information 13A is information corresponding to a workflow process 1 related to a subject 1, while the information 13B is information corresponding to a workflow process 2 related to a subject 2. The number of pieces of information stored in the application type 11 segment 13 may be zero, may be one, or may be three or more.

The information 13A and 13B may also be associated with a single subject. In other words, multiple pieces of information may be associated with a single subject. For example, the information 13A is used for output in a first language (for example, the Japanese language, or for a first OS), while the information 13B is used for output in a second language (for example, the English language, or for a second OS). Which language in which to output a workflow process may be specified by the user via a selection screen, for example. A workflow process includes actions such as saving, displaying, aggregating, transmitting, or acquiring information included in the subject associated with the information 13A and 13B, for example. In addition, a workflow process includes displaying an operation panel for controlling the operation of real equipment corresponding to the subject associated with the information 13A and 13B. Note that both of the information 13A and 13B may be provided for separate types of operations on a single piece of equipment. For example, the information 13A may be used to operate the channel of a television receiver, whereas the information 13B may be used to operate the power button of the television receiver.

The information 13A and 13B is stated as text. The present exemplary embodiment uses JavaScript Object Notation (JSON), which is an example of an execution language stated in text. JSON (registered trademark) is a language that uses part of the object notation in JavaScript (registered trademark) as the basis of syntax. Obviously, the execution language used to state a workflow process is not limited to JSON.

<Configuration of Image Processing System and Information Processing Device>

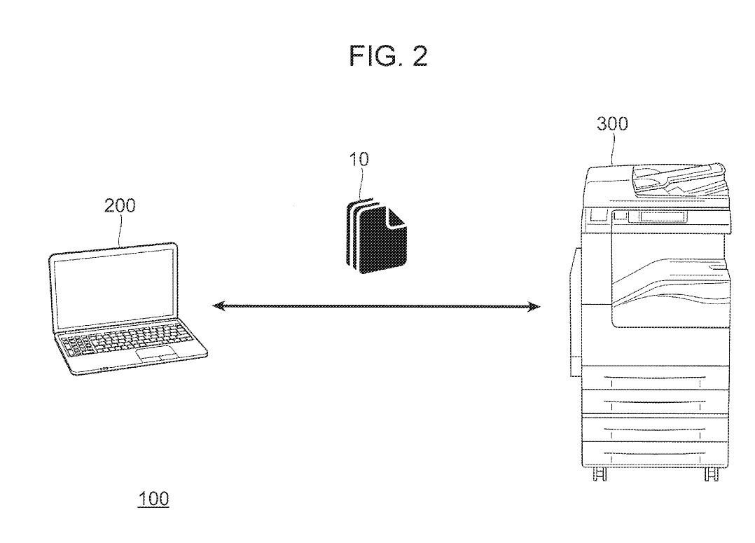

FIG. 2 is a diagram illustrating an exemplary configuration of an image processing system 100 used in the present exemplary embodiment. The image processing system 100 includes a portable computer 200 that a user uses to look at images, and an image forming device 300 used to print or fax still images. Herein, the computer 200 and the image forming device 300 are both examples of an information processing device. FIG. 2 illustrates a state in which the computer 200 and the image forming device 300 are connected via a communication medium (not illustrated), and JPEG files 10 are exchanged. However, each of the computer 200 and the image forming device 300 may also be used independently.

The device used as the computer 200 may be a notebook computer, a tablet computer, a smartphone, a mobile phone, a camera, or a mobile game console, for example. The image forming device 300 in the present exemplary embodiment is a device equipped with a copy function, a scan function, a fax transmission and reception function, and a print function. However, the image forming device 300 may also be a device specializing in a single function, such as a scanner, a fax machine, a printer (including 3D printer), or an image editing device, for example.

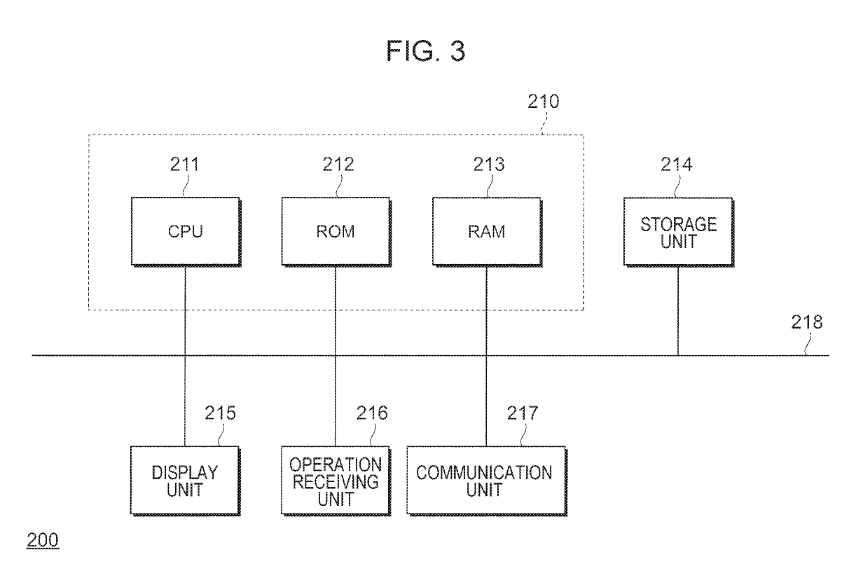

FIG. 3 is a diagram illustrating an exemplary configuration of the computer 200 according to the exemplary embodiment. The computer 200 includes a control unit 210 that controls the device overall, a storage unit 214 used to store data such as the JPEG file 10, a display unit 215 sued to display images, an operation receiving unit 216 that receives input operations from the user, and a communication unit 217 used to communicate with an external device (for example, the image forming device 300). The above components are connected to a bus 218, and exchange data with each other via the bus 218.

The control unit 210 is an example of a controller, and is made up of a central processing unit (CPU) 211, read-only memory (ROM) 212, and random access memory (RAM) 213. The ROM 212 stores programs executed by the CPU 211. The CPU 211 reads out a program stored in the ROM 212, and executes the program using the RAM 213 as a work area. Through the execution of programs, workflow processes prescribed by the information 13A and 13B discussed earlier are executed. A specific example of a workflow process will be discussed later.

The storage unit 214 is made up of a storage device such as a hard disk device or semiconductor memory. The display unit 215 is a display device that displays various images through the execution of a program (including an operating system and firmware). The display unit 215 is made up of a liquid crystal display panel or an organic electroluminescence (EL) display panel, for example. The operation receiving unit 216 is a device that accepts operations from the user, and is made up of devices such as a keyboard, one or more buttons and switches, a touchpad, or a touch panel, for example. The communication unit 217 is made up of a local area network (LAN) interface, for example.

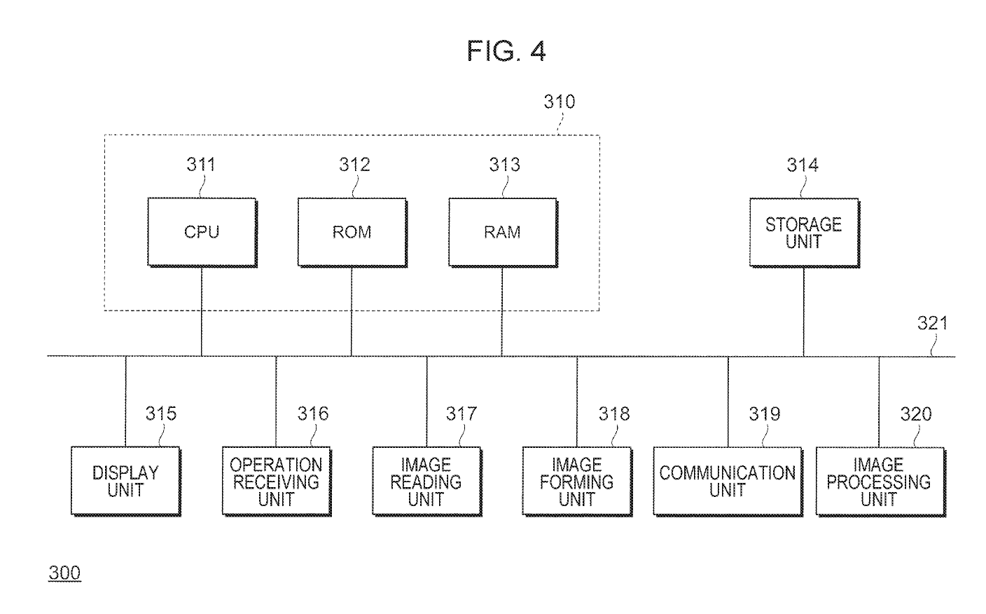

FIG. 4 is a diagram illustrating an exemplary configuration of the image forming device 300 according to the exemplary embodiment. The image forming device 300 includes a control unit 310 that controls the device overall, a storage unit 314 used to store data such as the JPEG file 10, a display unit 315 used to display an operation reception screen and still images, an operation receiving unit 316 that receives input operations from the user, an image reading unit 317 that reads an image of a placed original and generates image data, an image forming unit 318 that forms an image on a paper sheet, which is one example of a recording medium, by an electrophotographic method or an inkjet method, for example, a communication unit 319 used to communicate with an external device (for example, the computer 200), and an image processing unit 320 that performs image processing such as color correction and tone correction on an image expressed by image data. The above components are connected to a bus 321, and exchange data with each other via the bus 321.

The control unit 310 is an example of a controller, and is made up of a central processing unit (CPU) 311, read-only memory (ROM) 312, and random access memory (RAM) 313. The ROM 312 stores programs executed by the CPU 311. The CPU 311 reads out a program stored in the ROM 312, and executes the program using the RAM 313 as a work area. Through the execution of a program, the respective components of the image forming device 300 are controlled. For example, operations such as the formation of an image onto the surface of a paper sheet and the generation of a scanned image are controlled.

The storage unit 314 is made up of a storage device such as a hard disk device or semiconductor memory. The display unit 315 is a display device that displays various images through the execution of a program (including an operating system and firmware). The display unit 315 is made up of a liquid crystal display panel or an organic electroluminescence (EL) display panel, for example. The operation receiving unit 316 is a device that accepts operations from the user, and is made up of devices such as one or more buttons and switches, or a touch panel, for example.

The image reading unit 317 is commonly referred to as a scanner device. The image forming unit 318 is a print engine that forms an image onto a paper sheet, which is one example of a recording medium, for example. The communication unit 319 is made up of a local area network (LAN) interface, for example. The image processing unit 320 is made up of a dedicated processor that performs image processing such as color correction and tone correction on image data, for example.

### Still Image Example

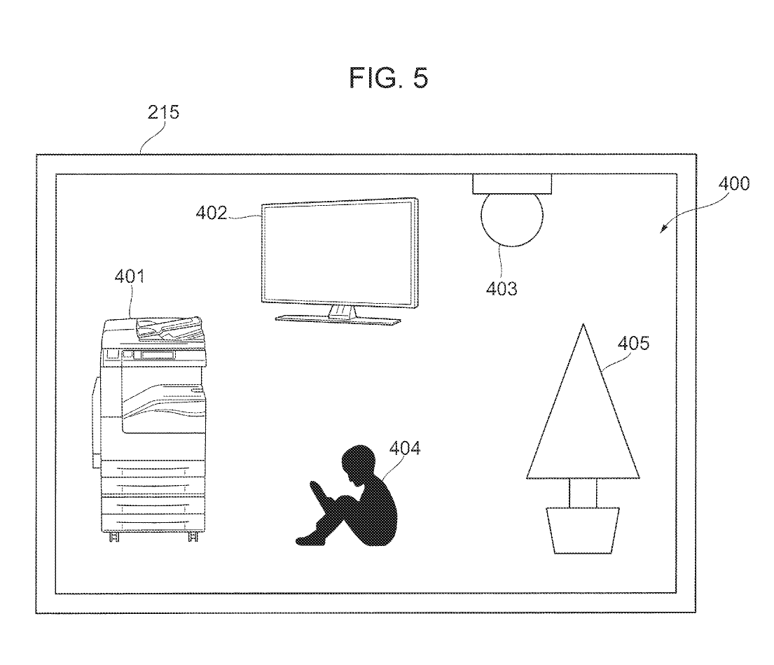

First, an example of a still image used in respective usage scenarios will be described. Note that since a moving image is constructed as a time series of multiple still images, the still image described below is also applicable to the case of a moving image. FIG. 5 is a diagram illustrating an example of a still image used in respective usage scenarios. The still image 400 displayed on the display unit 215 corresponds to an electronic photograph saved onto a recording medium in the case of imaging an office interior with a digital camera, for example. As discussed earlier, the still image 400 is saved in the image data 14 of the JPEG file 10. The still image 400 depicts an image forming device 401, a television receiver 402, a lighting fixture 403, a person 404, and a potted plant 405 as subjects. In the case of the present exemplary embodiment, the information 13A associated with at least one of these five subjects is stated in the attribute information 16 of the JPEG file 10 corresponding to the still image 400.

<Configuration Related to Decoding Function>

The respective usage scenarios discussed later are realized by the computer 200, by the computer 200, or by the cooperation of the computer 200 and the image forming device 300. In the following description, unless specifically noted otherwise, the respective usage scenarios are realized by the computer 200. Also, unless specifically noted otherwise, one piece of information 13A for one subject is taken to be stated in the attribute information 16 of the JPEG file 10. The information 13A is information prescribing a workflow process related to one subject, and is stated in JSON.

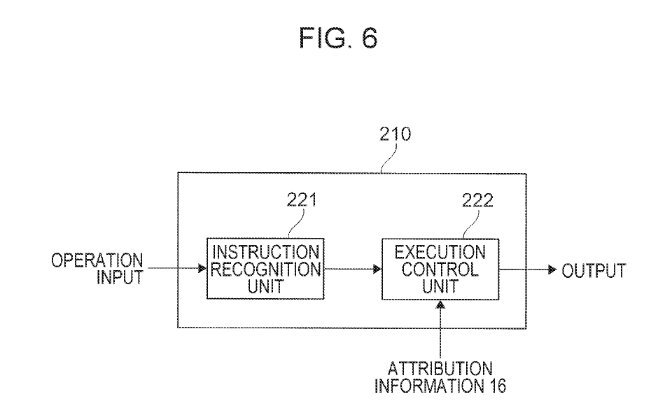

FIG. 6 is a block diagram illustrating an example of a functional configuration of the control unit 210 expressed from the perspective of a function that processes the JPEG file 10 including information 13A prescribing a workflow process as attribute information 16. The control unit 210 functions as an instruction recognition unit 221 used to recognize a user instruction input via the operation receiving unit 216, and an execution control unit 222 that controls the execution of the information 13A prescribing a workflow process related to a subject. Herein, the instruction recognition unit 221 is an example of a recognition unit, while the execution control unit 222 is an example of a controller.

The user instruction is recognized as a selection of a subject included in the still image 400. The user instruction position is given as coordinates (pixel value, pixel value) in a coordinate system defined for the still image 400 (for example, a coordinate system that takes the origin to be the upper-left corner of the screen). The instruction position may be recognized as the position of a cursor displayed overlaid onto the still image 400, or may be recognized by a touch panel sensor disposed in front of the display unit 215 (on the user side), as a position touched by the user.

The execution control unit 222 executes the following process when the information 13A prescribing a workflow process related to a subject is stated as part of the attribute information 16 attached to the JPEG file 10. First, the execution control unit 222 determines whether or not the instruction position recognized by the instruction recognition unit 221 is included in a region or range associated with the information 13A. If the instruction position recognized by the instruction recognition unit 221 is not included in the region or range associated with the information 13A, the execution control unit 222 does not execute the workflow process prescribed by the information 13A. On the other hand, if the instruction position recognized by the instruction recognition unit 221 is included in the region or range associated with the information 13A, the execution control unit 222 executes the workflow process prescribed by the information 13A.

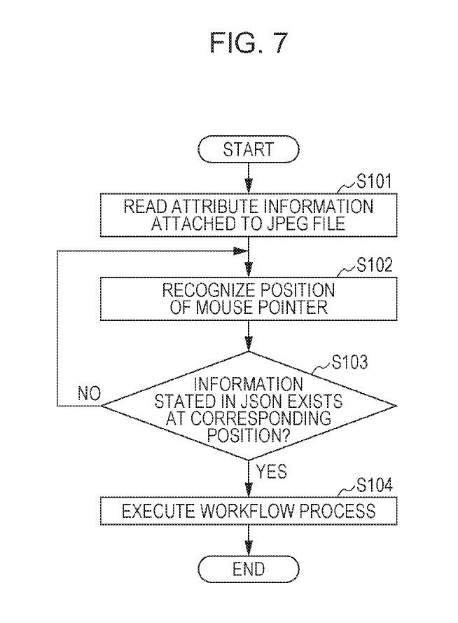

Next, a processing sequence executed by the control unit 210 will be described. FIG. 7 is a flowchart illustrating an example of a processing sequence executed by the control unit 210. First, after reading out the JPEG file 10 corresponding to the still image 400 displayed on the display unit 215, the control unit 210 reads the attribute information 16 attached to the JPEG file 10 (step 101).

Next, the control unit 210 recognizes the position of the mouse pointer on the still image 400 displayed on the display unit 215 (step 102). After that, the control unit 210 determines whether or not the information 13A stated in JSON is associated with the position specified by the mouse pointer (step 103). If a negative determination result is obtained in step 103, the control unit 210 returns to step 102. This means that the information 13A is not associated with the region of the still image 400 indicated by the mouse pointer. In contrast, if a positive determination result is obtained in step 103, the control unit 210 executes the workflow process stated in JSON (step 104). The content of the executed workflow process is different depending on the stated content.

<Usage Scenarios>

Hereinafter, usage scenarios realized through the execution of the information 13A stated in the application segment 13 of the attribute information 16 will be described.

<Usage Scenario 1>

At this point a case will be described in which information 13A prescribing a workflow process related to the lighting fixture 403, which is one of the subjects in the still image 400, is stated in the attribute information 16 of the JPEG file 10. In other words, in the case of Usage Scenario 1, information 13A corresponding to the image forming device 401, the television receiver 402, the person 404, or the potted plant 405 is not stated in the attribute information 16.

In the workflow process in Usage Scenario 1, the following operations are executed sequentially: checking the user-supplied instruction position, displaying an operation screen for controlling the switching on and off of the lighting fixture 403, receiving operation input with respect to the displayed operation screen, outputting a command signal corresponding to the received operation input, and changing the display state of the lighting fixture 403.

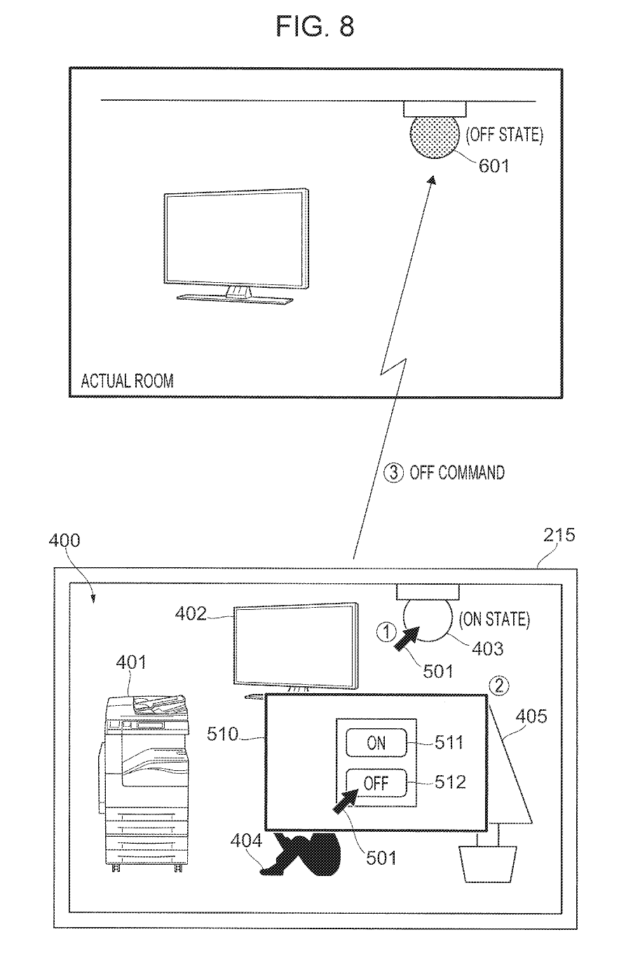

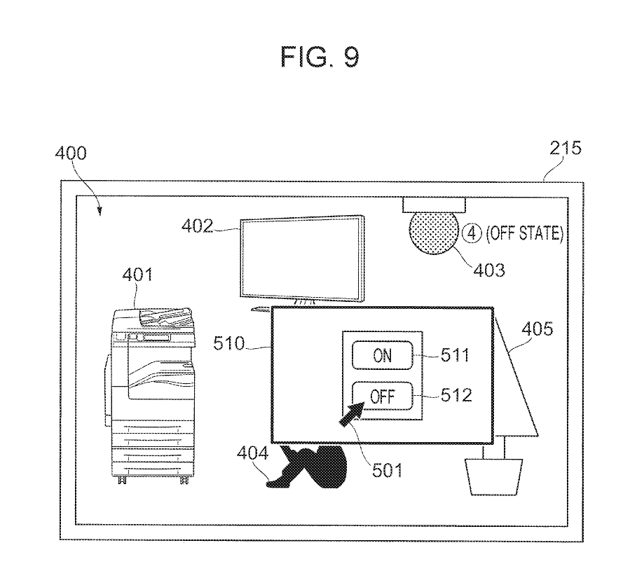

Hereinafter, the state of execution of a workflow process in Usage Scenario 1 will be described using FIGS. 8 and 9. FIG. 8 is a diagram explaining up to the output of a command in Usage Scenario 1. FIG. 9 is a diagram explaining an example of a change added to the still image 400 in Usage Scenario 1.

First, the user causes the still image 400 to be displayed on the screen of the display unit 215. Subsequently, the attribute information 16 of the still image 400 is given to the execution control unit 222. The execution control unit 222 decodes the content stated in the attribute information 16, and specifies a region or range associated with the information 13A stated in the application segment 13.

Next, the user moves a mouse pointer 501 over the lighting fixture 403 in the still image 400 (the step denoted by the circled numeral 1 in the drawing). If a touch panel sensor is disposed in front of the display unit 215, this operation is performed by a touch operation using a fingertip. Note that the lighting fixture 403 in the still image 400 is in the state at the time of capturing the image, and thus is in the on state. The user's operation input is received via the operation receiving unit 216, and given to the instruction recognition unit 221.

In this usage scenario, since the information 13A is associated with the lighting fixture 403, the instruction recognition unit 221 executes the workflow process stated in the information 13A. First, a popup window 510 for operating the lighting fixture 403 is displayed on the screen of the display unit 215 (the step denoted by the circled numeral 2 in the drawing). In the popup window 510, an On button 511 and an Off button 512 are illustrated. Next, the user moves the mouse pointer 501 over the Off button 512, and clicks the Off button 512. This operation input is given to the instruction recognition unit 221 from the operation receiving unit 216. The popup window 510 is an example of a screen associated with a subject.

The execution control unit 222, upon recognizing that the Off button 512 has been clicked, transmits an off command to the actual lighting fixture 601 depicted in the still image 400 (the step denoted by the circled numeral 3 in the drawing). A command signal relevant to the control of the lighting fixture 601 is preregistered in the computer 200. Note that if the lighting fixture 601 includes an infrared receiver, and turning on or off is executed by the reception of an infrared signal, the execution control unit 222 outputs the off command using an infrared emitter (not illustrated) provided in the computer 200.

As a result, the lighting fixture 601 changes from an on state to an off state. In other words, the still image 400 is used as a controller for the actual lighting fixture 601. Note that the output destination for the off command may also be an actual remote control used to operate the lighting fixture 601. In this case, the off command is transmitted to the lighting fixture 601 via the remote control.

Meanwhile, the JPEG file 10 corresponding to the still image 400 is digital data, and thus is easily distributed to multiple users. In other words, it is easy to share the virtual controller among multiple people. Consequently, constraints such as in the case of sharing a physical controller among multiple people do not occur. For this reason, the turning on and off of the actual lighting fixture 601 is operated via each person's computer 200. Furthermore, the actual lighting fixture 601 has a one-to-one correspondence with the lighting fixture 403 in the still image 400, that is, the captured image. For this reason, intuitive specification of the control target by the user is realized. Also, to make it easy to understand the conditions of the control of a subject by multiple users, information such as the name of the current operator may be displayed on a virtual controller displayed in the still image 400.

Note that if the actual lighting fixture 601 or remote control supports the Internet of Things (IoT), the location of the user viewing the still image 400 and the installation location of the actual lighting fixture 601 may be physically distant. However, an additional mechanism for specifying the lighting fixture 601 to control may be beneficial. To specify the lighting fixture 601, information such as information about the imaging position, unique information assigned to each piece of equipment, or an address for communication assigned to each piece of equipment may be used as appropriate.

Subsequently, as illustrated in FIG. 9, the execution control unit 222 in Usage Scenario 1 applies a change to the display mode of the lighting fixture 403 included in the still image 400 by image processing (the step denoted by the circled numeral 4 in the drawing). For example, the display brightness of a corresponding region is lowered to indicate that the lighting fixture 403 has been turned off. Note that a representational image of the lighting fixture 403 in the off state may also be created, and the display of the lighting fixture 403 may be replaced by the created representational image.

In other words, the still image 400 is used to confirm that the actual lighting fixture 601 has changed to the off state. The function of changing the display mode of a subject in accordance with the control content in this way improves user convenience when the turning on or turning off of the lighting fixture 601 is controlled from a remote location. Obviously, if the subjects depicted in the still image 400 are controlled by multiple users, the display mode changed as a result of controlling each subject may be applied to each still image. Note that even if the still image 400 itself is different, if the same subject is depicted, the condition of the same subject may be acquired via a network, and the display mode of the same subject depicted in each still image may be changed.

The foregoing describes a case in which the lighting fixture 403 is specified on the still image 400, but if the television receiver 402 is specified on the still image 400, for example, an operation screen including elements such as a power switch, buttons for changing the channel, buttons for selecting a channel, and volume adjustment buttons may also be displayed on the still image 400, on the basis of the information 13A stated in the attribute information 16 of the JPEG file 10 corresponding to the still image 400. Also, if a motorized window or door is specified, buttons for opening and closing the window or door may be displayed. Likewise in these cases, the color and shape of the subject displayed in the still image 400 may be altered to reflect the result of an operation.

In addition, if multiple functions realized through workflow processes are made available for a single still image 400, when the JPEG file 10 is read in, a list of the available functions may also be displayed in the still image 400. However, this display may also be conducted when the mouse pointer 501 indicates a subject for which information 13A is stated. Also, if only one subject with registered information 13A is depicted in the still image 400, when the JPEG file 10 corresponding to the still image 400 is read in, a predetermined workflow process may be executed even without giving an instruction using the mouse pointer 501.

In this usage scenario, the computer 200 is equipped with a function of decoding the application segment 13, but a computer 200 not equipped with the decoding function obviously may be unable to execute a workflow process prescribed by the information 13A. In this case, the computer 200 may search, via a communication medium, for an external device equipped with the function of decoding the application segment 13, and realize the above function by cooperating with a discovered external device. For example, the attribute information 16 (at least the application segment 13) may be transmitted from the computer 200 to the image forming device 300 for decoding, and a decoded result may be acquired from the image forming device 300.

<Usage Scenario 2>

At this point, an example will be described for a process executed when editing or copying the corresponding still image 400 in a case in which the attribute information 16 of the JPEG file 10 includes the information 13A prescribing a workflow process related to a subject. Note that the process in Usage Scenario 2 likewise is executed by the control unit 210 of the computer 200.

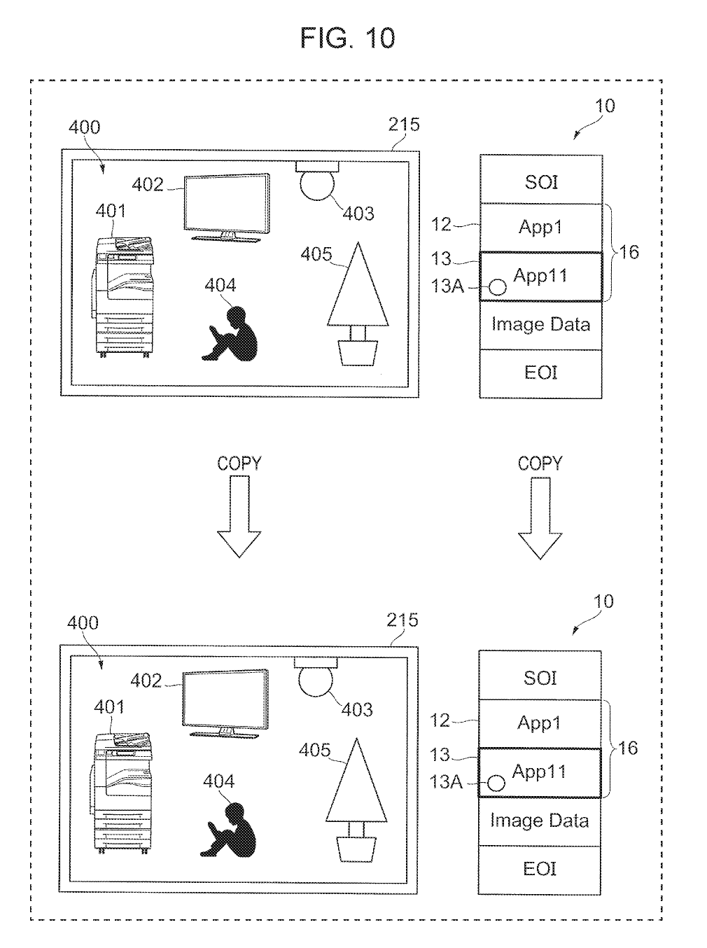

FIG. 10 is a diagram explaining an exemplary operation in a case of copying the JPEG file 10 in which the information 13A prescribing a workflow process is stated in the attribute information 16. In FIG. 10, the entirety of the JPEG file 10 is copied, and thus the attribute information 16 is also included. If the JPEG file 10 copied in this way is distributed to multiple users, a usage scenario is realized in which multiple people respectively operate actual pieces of equipment corresponding to subjects via the still image 400, as discussed earlier.

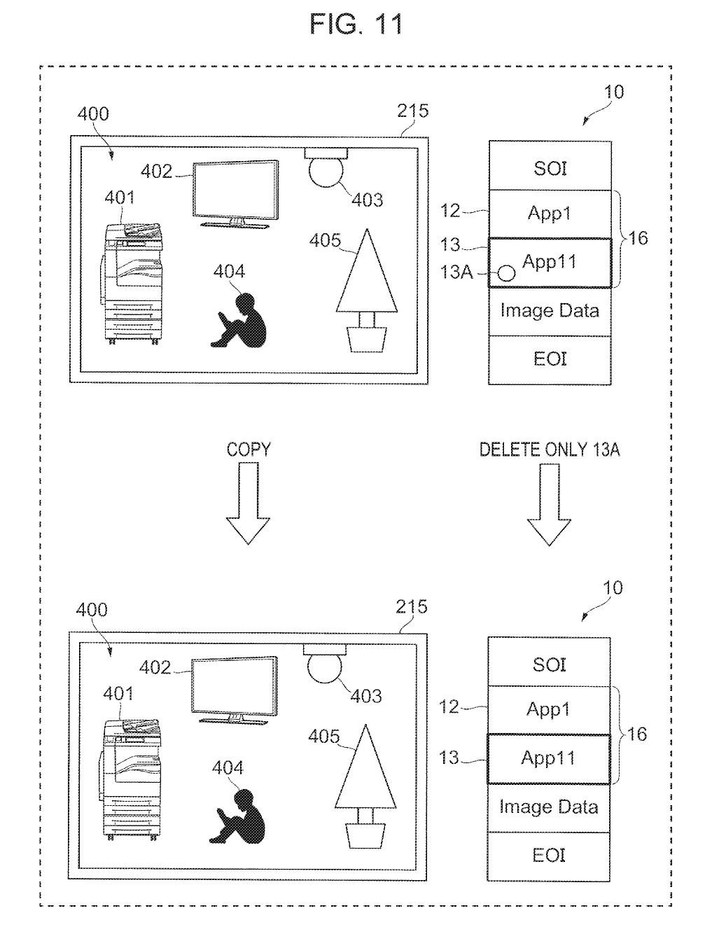

FIG. 11 is a diagram explaining another exemplary operation in a case of duplicating the JPEG file 10 in which the information 13A prescribing a workflow process is stated in the attribute information 16. In FIG. 11, when copying the JPEG file 10, the information 13A is deleted from the attribute information 16. In this case, only the user possessing the original electronic photograph has the right to control actual pieces of equipment corresponding to subjects from the still image 400. Note that when copying the JPEG file 10, the user may make a selection about whether to copy all of the attribute information 16 or delete the information 13A from the attribute information 16. The selection at this point may be made in advance, or may be made through an operation screen displayed at the time of copying.

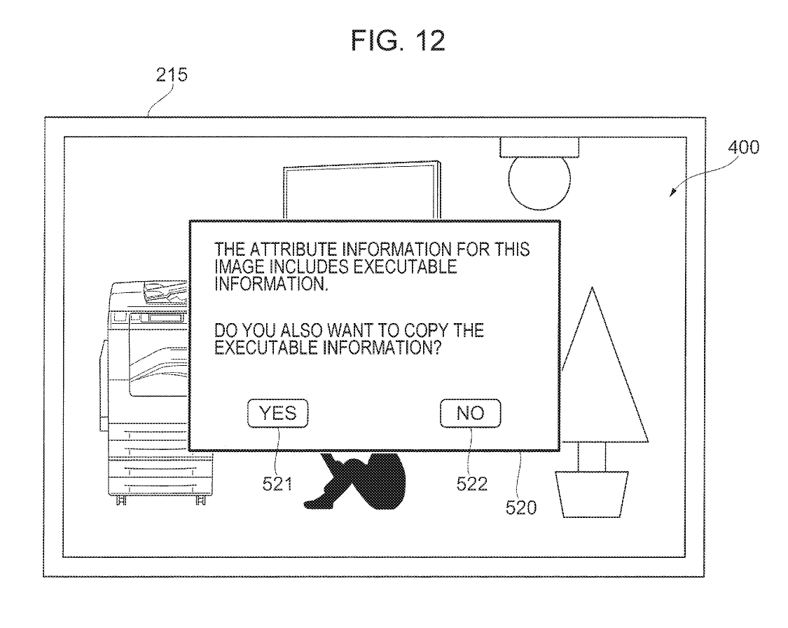

FIG. 12 is a diagram illustrating an exemplary display of a popup window 520 to confirm the copying of the information 13A prescribing a workflow process, displayed at the time of copying the JPEG file 10. The popup window 520 includes content which indicates that executable information 13A is included in the attribute information 16 of the JPEG file 10 to be copied, and which seeks confirmation of whether the executable information 13A may also be copied. Note that if a Yes button 521 is selected by the user, the control unit 210 copies all of the attribute information 16, whereas if a No button 522 is selected by the user, the control unit 210 copies the attribute information 16 with the information 13A deleted therefrom.

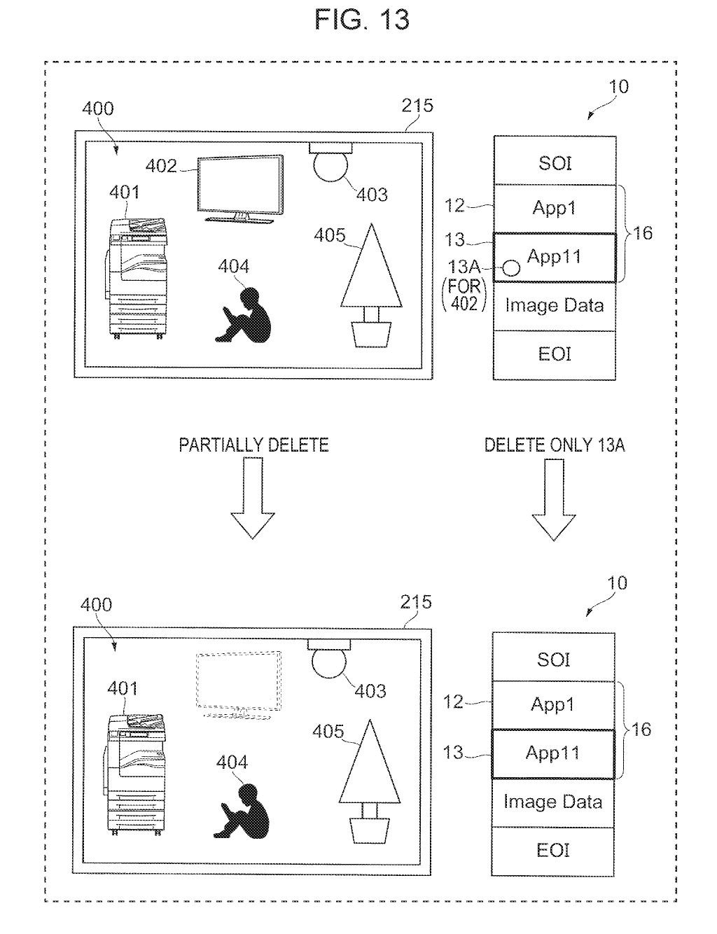

FIG. 13 is a diagram explaining an exemplary operation in a case of deleting a subject for which the information 13A prescribing a workflow process is stated in the attribute information 16 by image editing. In FIG. 13, the information 13A is associated with the television receiver 402, and the image of the television receiver 402 is deleted from the still image 400. In this case, the control unit 210 deletes the information 13A associated with the television receiver 402 from the attribute information 16. This deletion avoids an inexpedience in which an operation screen related to a subject that no longer exists in the still image 400 is displayed.

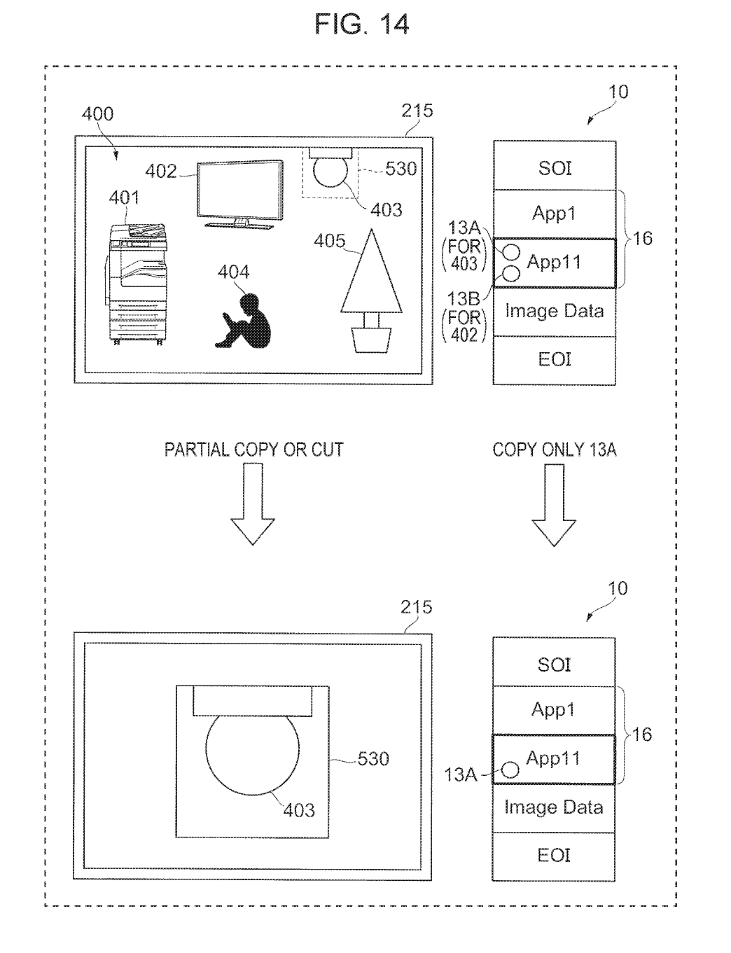

FIG. 14 is a diagram explaining an exemplary operation in a case of copying or cutting one subject for which the information 13A prescribing a workflow process is stated in the attribute information 16 by image editing. In FIG. 14, the information 13A is associated with the lighting fixture 403. Only the information 13A corresponding to the lighting fixture 403 is copied to the attribute information 16 of the newly created JPEG file 10 for the image portion of the lighting fixture 403 (the portion enclosed by the frame 530). In other words, the information 13B corresponding to the television receiver 402 is not copied. In this way, the information 13A stated in the attribute information 16 of the original still image 400 is copied to the new JPEG file 10, together with a partial image including the associated subject.

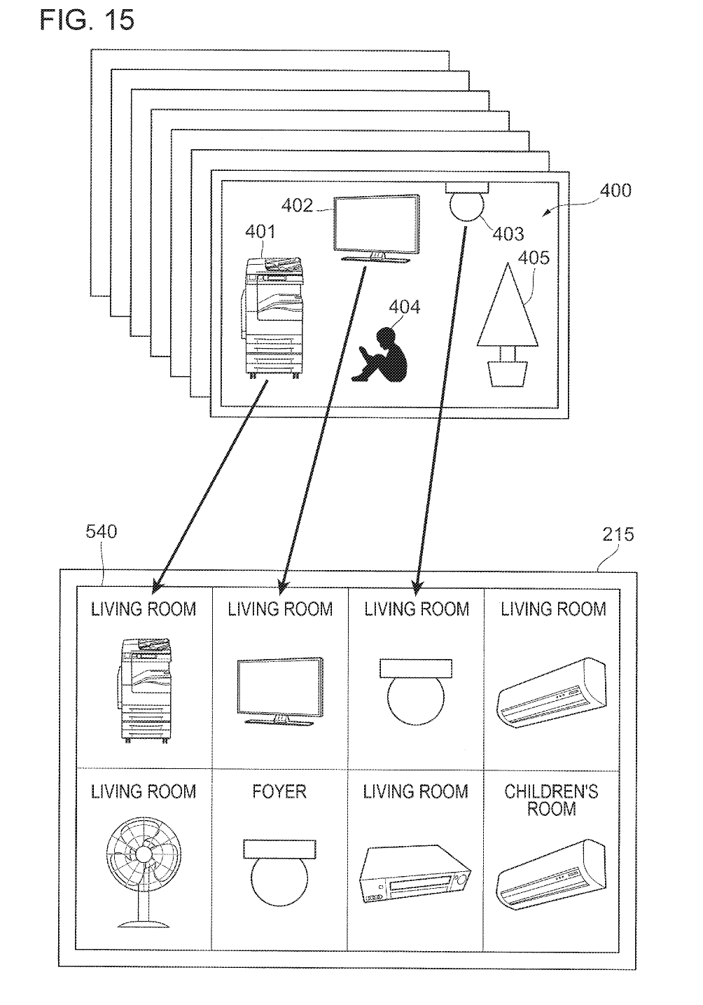

This function of copying a partial image may also be used to create an operation screen in which the pieces of electronic equipment included in the still image 400 are arranged on a single screen. FIG. 15 is a diagram illustrating an example of arranging small images of electronic equipment copied or cut from multiple still images 400 into a single still image 540. In the case of FIG. 15, the still image 540 includes an image of an imaging forming device, an image of a television receiver, an image of a lighting fixture, an image of an air conditioner, an image of a fan, and an image of a video recorder installed in a living room, as well as an image of a lighting fixture installed in a foyer, and an image of an air conditioner installed in a children's room. As discussed earlier, the JPEG files 10 corresponding to these images include the information 13A related to each subject, that is, each piece of electronic equipment. Consequently, the still image 540 is used as an operation screen for multiple pieces of electronic equipment.

<Usage Scenario 3>

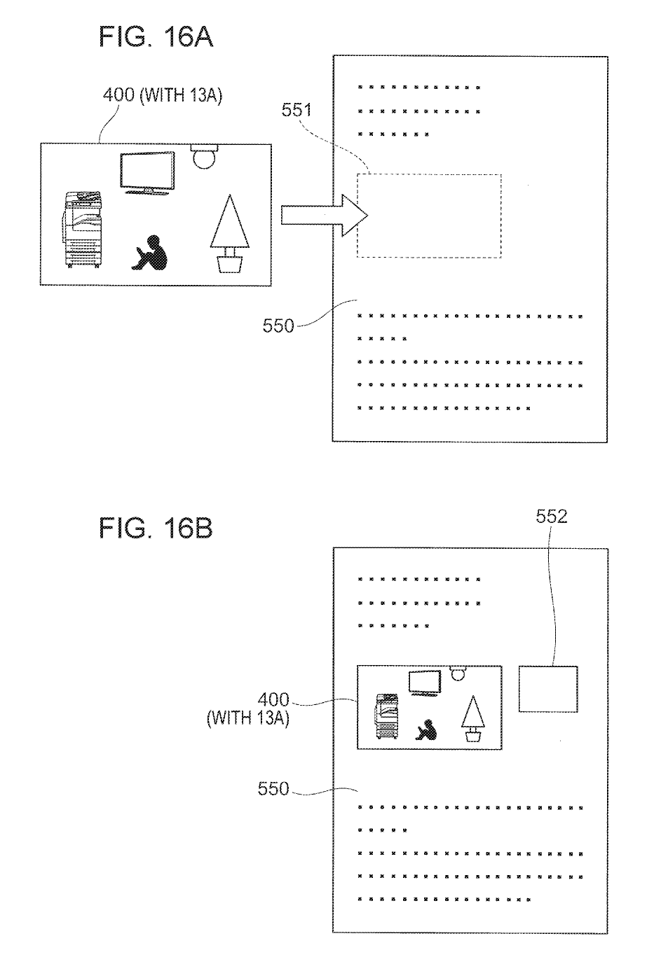

At this point, the provision of a new usage scenario realized by combining the JPEG file 10 with another document will be described. FIGS. 16A and 16B are diagrams explaining an exemplary screen that appears in a case of pasting the image of the JPEG file 10, in which the information 13A prescribing a workflow process is stated in the attribute information 16, into an electronic document 550. The electronic document 550 is an example of a document file. In the case of FIGS. 16A and 16B, the electronic document 550 includes a region 551 into which is embedded a statement in an execution language. In the region 551, there is stated, in HTML, content prescribing the layout position and size of a popup window 552 opened when the JPEG file 10 including the information 13A stated in an execution language is placed in the region 551, for example.

In this case, the content displayed in the popup window 552 is prescribed by the information 13A inside the JPEG file 10, while the layout position and size of the popup window 552 is prescribed by the content stated in the region 551 inside the electronic document 550. Consequently, a complex workflow process that may not be obtained with only the workflow process prescribed by the information 13A is realized. Note that by combining the statements of the information 13A and the region 551, special characters and graphics may be made to appear.

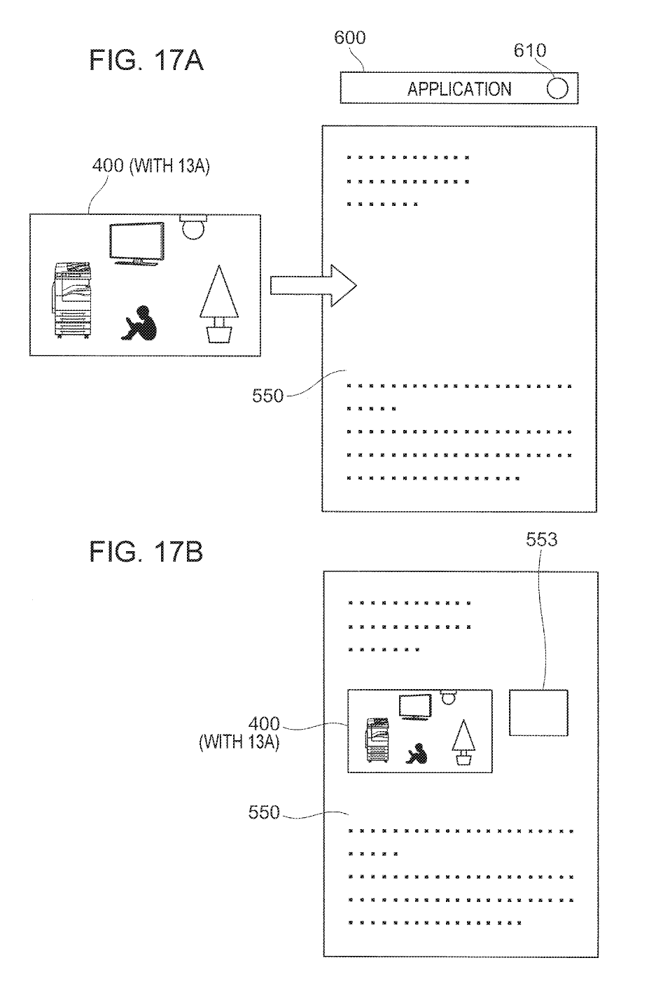

FIGS. 17A and 17B are diagrams explaining another exemplary screen that appears in a case of pasting the image of the JPEG file 10, in which the information 13A prescribing a workflow process is stated in the attribute information 16, into the electronic document 550. FIGS. 17A and 17B illustrate an example in which the information 13A stated in an execution language is made to operate in combination with a macro 610 of an application 600 that displays the electronic document 550, and the execution result is displayed as a popup window 553. For example, price information about subjects collected by the workflow process of the information 13A may be aggregated using the macro. In addition, if the subjects are receipts, the information 13A may also be content that extracts the fee portion, and gives the extracted fee portion to the macro.

<Usage Scenario 4>

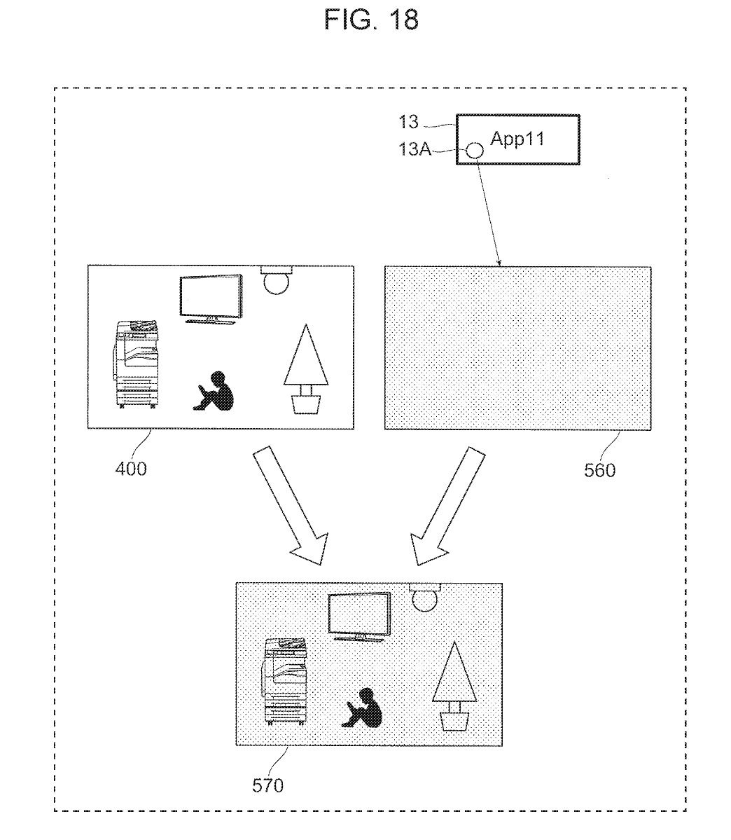

At this point, operation will be described for a case of printing an image of the JPEG file 10, in which the information 13A prescribing a workflow process is stated in the attribute information 16, onto a recording medium, that is, a paper sheet. In the foregoing usage scenarios, the copying of the attribute information 16 is executed in the form of a data file, but in this usage scenario, the copying is performed using a paper sheet. FIG. 18 is a diagram explaining a usage scenario of embedding into the still image 400 and printing a coded image 560 with low visibility expressing the content of the attribute information 16.

The coded image 560 with low visibility is an image made up of hard-to-notice microscopic dots arranged in the background of the output document. For example, MISTCODE (Micro-dot Iterated and Superimposed Tag CODE) may be used as the technology for creating the coded image 560. MISTCODE is made up of a pattern obtained by arranging dots according to certain rules, and this pattern is distributed throughout a paper sheet to embed information. The control unit 210 of the computer 200 generates a composite image 570 in which the coded image 560 with low visibility created from the attribute information 16 is embedded into the still image 400, and gives this information to the image forming device 300.

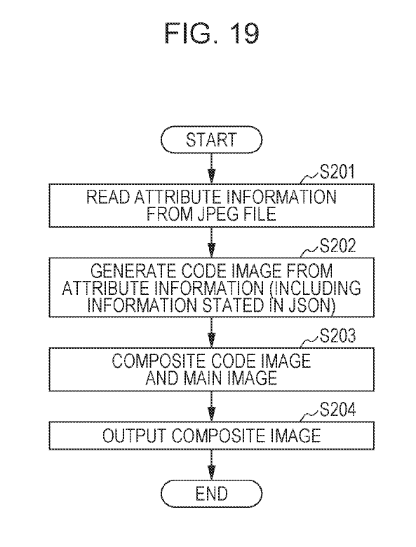

FIG. 19 is a flowchart illustrating an example of a process executed by the control unit 210 in a case of printing the JPEG file 10. First, upon receiving a print instruction, the control unit 210 acquires the attribute information 16 from the JPEG file 10 to be printed (step 201). Next, the control unit 210 generates the coded image 560 from the attribute information 16 (step 202). However, the information 13A prescribing a workflow process may also be deleted when printing.

After that, the control unit 210 composites the generated coded image 560 with the still image 400 corresponding to the main image (that is, the image data 14), and generates the composite image 570 (step 203). After that, the control unit 210 outputs the composite image 570 to the image forming device 300 (step 204). Note that the process of compositing the coded image 560 and the still image 400 may also be executed inside the image forming device 300.

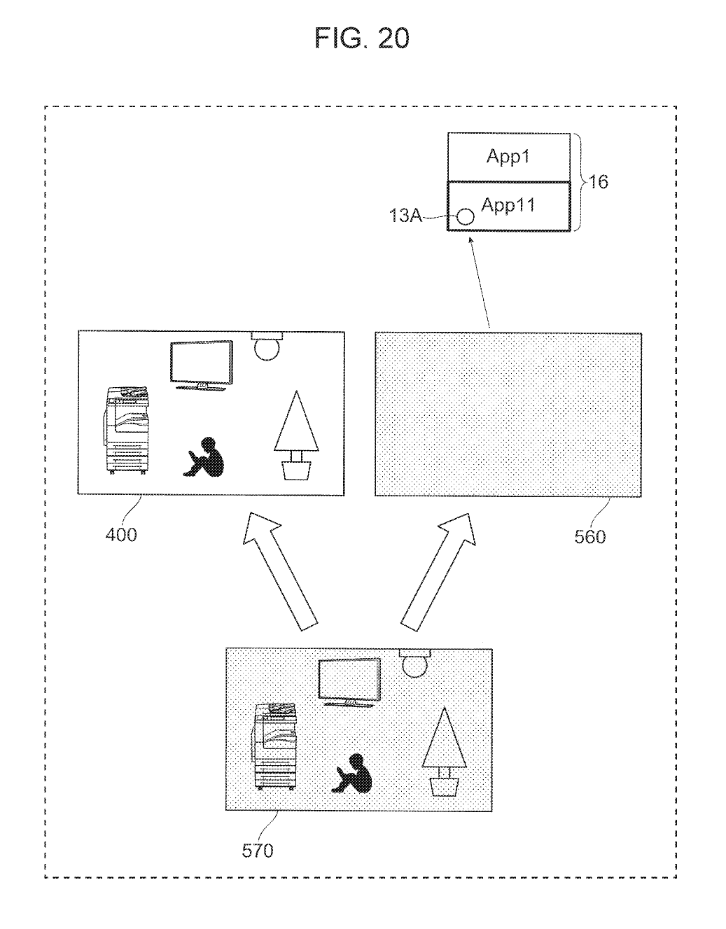

In the case of receiving the composite image 570, a reverse process is executed. FIG. 20 is a diagram explaining how the coded image 560 and the still image 400 are separated from the composite image 570, and the attribute information 16 is reconstructed from the coded image 560. The flow of the process in FIG. 20 goes in the reverse direction of the flow of the process in FIG. 18.

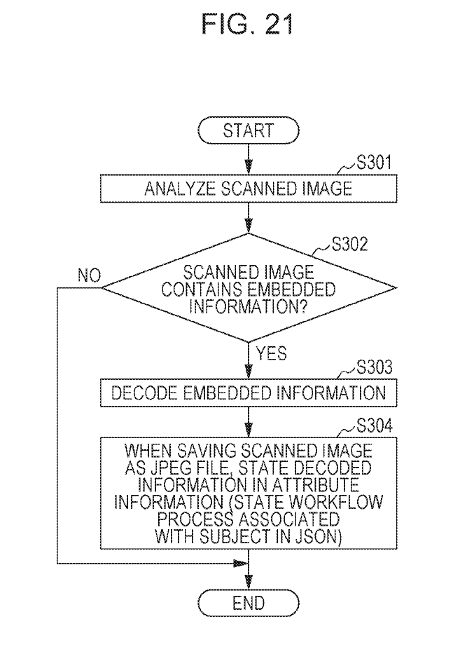

FIG. 21 is a flowchart illustrating an example of a process executed by the control unit 210 in a case in which the coded image 560 generated from the attribute information 16 is embedded into a printed image. FIG. 21 is the operation in a case in which a scanned image generated by the image forming device 300 equipped with a scanner is acquired by the computer 200 via a communication medium. Obviously, the image forming device 300 may also execute the process discussed below.

First, the control unit 210 analyzes the scanned image (step 301). Next, the control unit 210 determines whether or not the scanned image contains embedded information (step 302). If a negative determination result is obtained in step 302, the control unit 210 ends the flow without executing the processes discussed below. On the other hand, if a positive determination result is obtained in step 302, the control unit 210 decodes the information embedded in the scanned image (step 303). Specifically, the coded image 560 is decoded. After that, the control unit 210 saves the scanned image as the JPEG file 10, and at this point, states the decoded information in the attribute information 16 (step 304). Note that the workflow process associated with the application segment 13 is stated in JSON.

By providing the computer 200 with the above processing functions, the JPEG file 10 that includes the information 13A prescribing a workflow process is generated from printed material in which the attribute information 16 of the JPEG file 10 is embedded as the coded image 560.

<Usage Scenario 5>

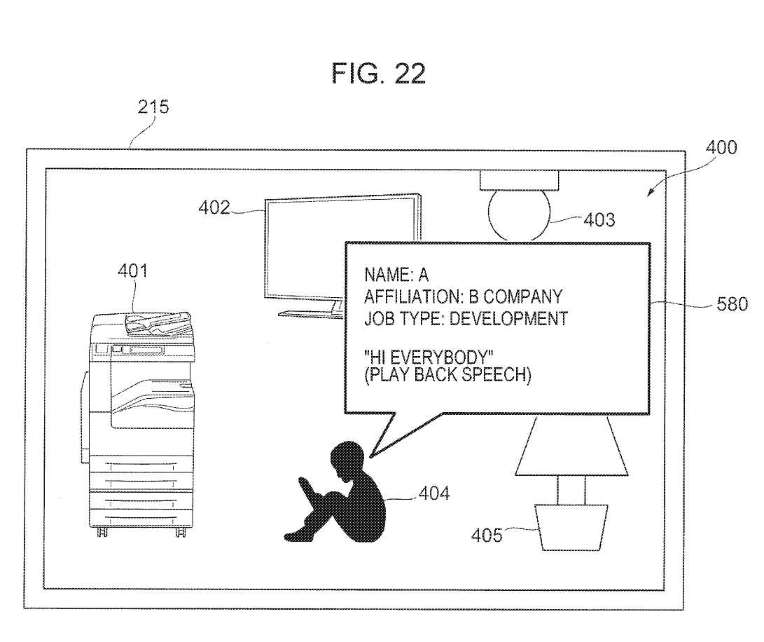

The foregoing usage scenarios suppose a case in which the information 13A prescribing a workflow process is associated with a subject, that is, a piece of equipment. However, the information 13A prescribing a workflow process may also be attached to objects such as the person 404 or the potted plant 405. FIG. 22 is a diagram explaining a case in which the information 13A prescribing a workflow process is stated in association with the person 404.

In the case of FIG. 22, if the person 404 is specified by the mouse pointer 501, the control unit 210 reads out the information 13A from the attribute information 16, and executes the workflow process stated in the information 13A. In this example, by the execution of the workflow process, personal information about the subject, namely A, is read out from a database and displayed in a popup window 580. In addition, a speech file saying “Hi everybody” is played back. The speech playback at this point is an example of sound associated with a subject.

<Usage Scenario 6>

The foregoing usage scenarios describe functions executed by the computer 200 reading out the information 13A in a case in which the attribute information 16 of the JPEG file 10 includes the information 13A stating a workflow process related to a subject. The present usage scenario describes a case of recording the information 13A in the attribute information 16 of the JPEG file 10.

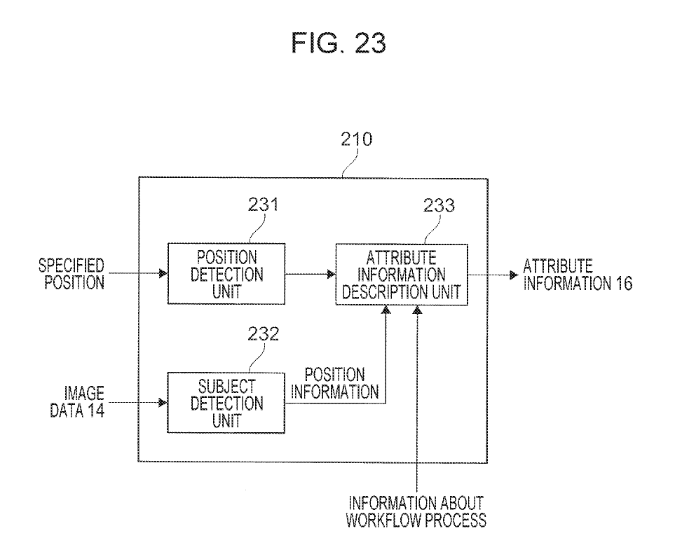

FIG. 23 is a block diagram illustrating an example of a functional configuration of the control unit 210 expressed from the perspective of recording the information 13A prescribing a workflow process. The control unit 210 functions as a position detection unit 231 that detects an image position specified by a user, a subject detection unit 232 that detects a subject matching a registered image using image processing technology, and an attribute information description unit 233 that states a workflow process in association with the detected position in the application segment 13 of the attribute information 16.

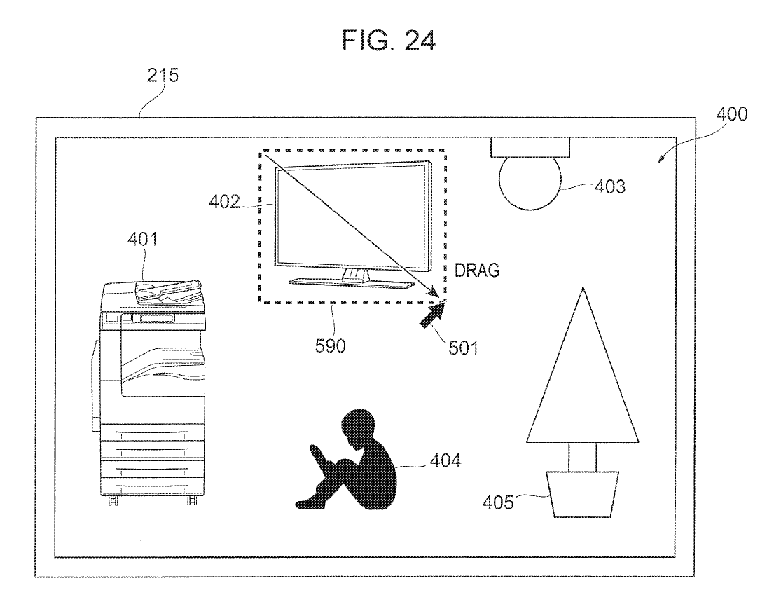

FIG. 24 is a diagram explaining an example of a user-specified image region. In FIG. 24, by dragging the mouse pointer 501, a region 590 is set so as to enclose the displayed position of the television receiver 402. Coordinate information expressing the region 590 is input into the position detection unit 231 as a specified position, and the position detection unit 231 outputs coordinate information of an ultimately decided region as position information.

The subject detection unit 232 is used when an image of the subject for which to record the information 13A has been registered in advance. The subject detection unit 232 matches the image data 14 included in the JPEG file 10 (that is, the still image 400) with the registered image, and outputs coordinate information at which a subject matching the registered image exists as position information.

The attribute information description unit 233 records the statement of a workflow process in the application segment 13 of the attribute information 16, in association with the position information. At this point, the statement of the workflow process may be edited by the user, or a statement prepared in advance may be used. Also, the workflow process is stated as text in JSON.

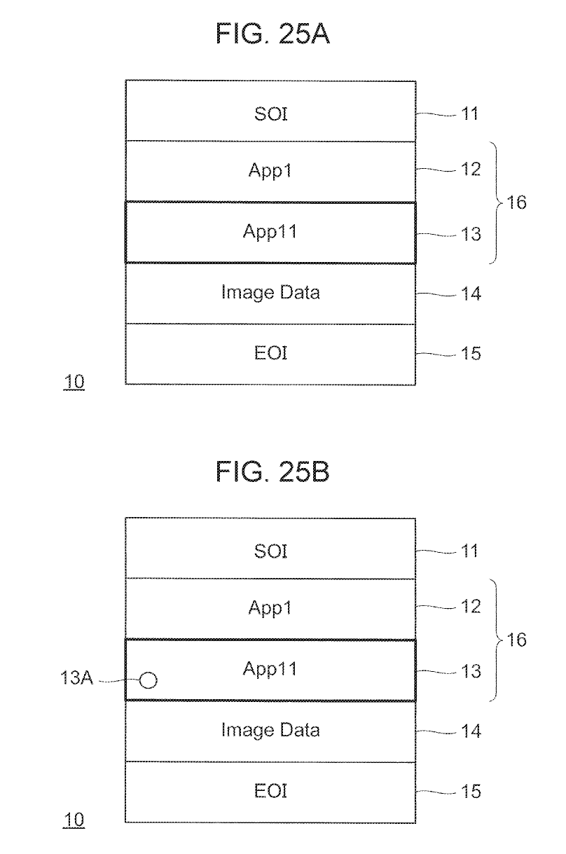

FIGS. 25A and 25B are diagrams explaining the writing of the information 13A prescribing a workflow process into the attribute information 16. The information 13A is not included in the attribute information 16 of the JPEG file 10 illustrated in FIG. 25A, but the information 13A is added to the attribute information 16 of the JPEG file 10 illustrated in FIG. 25B. In this way, a workflow process may also be added later to an existing JPEG file 10.

### Other Exemplary Embodiments

The foregoing thus describes an exemplary embodiment of the present invention, but the technical scope of the present invention is not limited to the scope described in the foregoing exemplary embodiment. In the foregoing exemplary embodiment, an exemplary embodiment of the present invention is described using a still image JPEG file as an example of an image file format, but the applicable file format is not limited to a still image or a JPEG file, and moving images as well as file formats other than JPEG are also applicable. It is clear from the claims that a variety of modifications or alterations to the foregoing exemplary embodiment are also included in the technical scope of the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device, comprising:
a recognition unit that recognizes a user instruction with respect to a subject included in an image; and
a controller that, if information related to the subject is stated in an execution language in a part of attribute information attached to a data file of the image, executes a workflow process prescribed by the information.

2. The information processing device according to claim 1, wherein
the data file of the image conforms to JPEG format, and the execution language is JSON.

3. The information processing device according to claim 1, wherein
the controller, through execution of the workflow process, outputs a screen or sound related to the subject.

4. The information processing device according to claim 3, wherein
the controller displays, as the screen, an operation screen for operating a piece of equipment treated as the subject.

5. The information processing device according to claim 4, wherein
the controller transmits, or causes to be transmitted, a command related to an operation received through the operation screen to the piece of equipment treated as the subject.

6. The information processing device according to claim 5, wherein
the controller applies a change to the display of the subject to reflect a state realized by the operation.

7. The information processing device according to claim 1, wherein
the controller causes an image forming device to output printed material in which a coded image used to reconstruct the attribute information or the information stated in the execution language is embedded into the image.

8. The information processing device according to claim 7, wherein
if printed material including the coded image output from the image forming device is read in, the controller states the information reconstructed from the coded image in a part of attribute information of a data file created for an image of the printed material.

9. The information processing device according to claim 1, wherein
the controller executes one function combining content of the information stated in the attribute information attached to the data file of the image, and content stated in an execution language inside a document of a document file into which the image is pasted.

10. The information processing device according to claim 1, wherein
the controller executes one function combining content of the information stated in the execution language in the attribute information included in the data file of the image, and content stated in an execution language registered in an application that opens a document file into which the image is pasted.

11. The information processing device according to claim 1, wherein
if the controller does not include a function of decoding the information stated in the execution language in the attribute information, the controller supplies the information to an external device for decoding.

12. The information processing device according to claim 11, wherein
the controller acquires a decoding result of the information from the external device to execute the workflow process.

13. The information processing device according to claim 1, wherein
if the subject is deleted from the image by image editing, the controller deletes the information related to the subject from the attribute information.

14. The information processing device according to claim 1, wherein
if an image portion of the subject is extracted and copied from the image by image editing, the controller copies the information stated about the subject into a part of attribute information attached to a data file newly created for the image portion.

15. The information processing device according to claim 1, wherein
if an image portion of the subject is extracted and copied from the image by image editing, the controller deletes the information stated about the subject from attribute information attached to a data file newly created for the image portion.

16. The information processing device according to claim 1, wherein
if an operation of copying the data file of the image is received, the controller causes a screen to be displayed, the screen prompting whether or not to copy the information included in the attribute information attached to the data file.

17. An information processing device, comprising:
a detection unit that detects a partial region corresponding to a subject in the image indicated by a user, or a predetermined partial region in which the subject exists in the image; and
a controller that states information prescribing, in an execution language, a workflow process related to the partial region in a part of attribute information attached to a data file of the image.

18. The information processing device according to claim 17, wherein
if a coded image expressing the information prescribing a workflow process is embedded into the image, the controller reconstructs the information from the coded image, and states the reconstructed information in a part of the attribute information attached to the image.

19. The information processing device according to claim 17, wherein
if the subject is a piece of equipment, the controller prepares, for individual types of operations, a plurality of the information including a statement giving an instruction to display an operation screen for the piece of equipment.

20. An image file data structure processed by an information processing device, the image file data structure comprising:
a first data region that stores an image itself; and
a second data region that stores attribute information about the image itself, the second data region including information prescribing, in an execution language, a workflow process related to a subject included in the image itself, wherein
if the subject in the image is indicated by a user, the information processing device is instructed to execute the workflow process prescribed by the information related to the subject.

21. A non-transitory computer readable medium storing a program causing a computer to execute a process for processing information, the process comprising:
recognizing a user instruction with respect to a subject included in an image; and
executing, if information related to the subject is stated in an execution language in a part of attribute information attached to a data file of the image, a workflow process prescribed by the information.

22. A non-transitory computer readable medium storing a program causing a computer to execute a process for processing information, the process comprising:
detecting a partial region corresponding to a subject in the image indicated by a user, or a predetermined partial region in which the subject exists in the image; and
stating information prescribing, in an execution language, a workflow process related to the partial region in a part of attribute information attached to a data file of the image.
